(19) United States
(12) Patent Application Publication
(10) Pub. No.: US 2011/0220575 A1
(43) Pub. Date: Sep. 15, 2011

(54) NEW CHROMATOGRAPHIC MEDIA BASED ON PHENOXY ALKYL AND ALKOXY-OR PHENOXY-PHENYL ALKYL LIGANDS

(76) Inventors: Nandu Deorkar, Cedar Knolls, NJ (US); Bhaklavachalam Thiyagarajan, Bethleham, PA (US)

(21) Appl. No.: 12/998,656

(22) PCT Filed: Nov. 16, 2009
(86) PCT No.: PCT/US2009/064536

§ 371 Date: May 16, 2011

Related U.S. Application Data
(60) Provisional application No. 61/115,993, filed on Nov. 19, 2008.

(51) Int. Cl. B01D 15/08; C07F 7/02

(52) U.S. Cl. 210/656; 556/400

(57) ABSTRACT

A reverse phase chromatographic media selected from media of the formula:

[X—C₆H₄—(O)ₘ—(CH₂)ₙ]_{q}—Z
and hydrophobic end-capped media of said formula,
   wherein n is a numeral of from 1 to 4, and m is 0 or 1, and when m is 1 X is selected from the group H, an alkyl group having from 1 to 6 carbon atoms and a phenyl group, and when m is 0 then X is selected from an alkoxy group having from 1 to 6 carbon atoms and a phenoxy group, Z is the backbone of a silica or hydrophilic polymer chromatographic support, and q is a number equal to the number of ligands attached to the backbone of the silica or hydrophobic polymer chromatographic support, with the proviso that when said reverse phase chromatographic media of the formula is not end-capped with hydrophobic groups X is not H when m=1.

These novel chromatographic media are prepared by reacting:
(a) a chromatographic media support selected from (1) a silica support having hydroxyl groups on the surface of the silica backbone or (2) a hydrophilic polymer support having hydroxyl, amine or imine groups on the surface of the polymer backbone,
   with
(b) a reactant of the formula

[X—C₆H₄—(O)ₘ—(CH₂)ₙ]ₚ—Si(Y)₄₋ₚ
wherein p is a numeral of from 1 to 3, Y is a chloro or alkoxy group having from 1 to 4 carbon atoms in the alkoxy group, and m, n and X are as defined above,
and optionally end-capping the resulting media by reacting it with a hydrophobic end-capping reactant.

The resulting chromatographic media with these ligands attached to the backbone of the silica or hydrophilic polymer support provides chromatographic media that offers analyte separation capability in the aqueous mobile phase.

### FIELD OF THE INVENTION

The invention relates to novel chromatographic media and use thereof for the separation and purification of small molecules. More particularly, the current invention discloses novel hydrophobic chromatographic media prepared by attaching phenoxy alkyl, alkoxy-phenyl or phenoxyphenyl type ligands that contains C—O—C bond to solid supports. The media may also have hydrophobic end-capping. The new chromatographic media provided in this invention is particularly useful for separation of a variety of molecules based on hydrophilic and pi-pi interactions. Furthermore, the new media can be used for separation of highly water-soluble compounds using just a highly aqueous mobile phase.

### BACKGROUND OF INVENTION

Reversed-phase HPLC media has found a wide utility for separating many basic compounds such as pharmaceuticals, agricultural chemicals, and peptides and small proteins. Several structurally suitable spherical silica particles and polymeric particles of well-defined diameter, pore size, pore volume, surface area and rigidity are available for both analytical and preparative scale HPLC. Also, chemically different silica-based and polymeric stationary phases media modified with polar and non-polar ligands are widely used. It is well known that besides the chemical nature of the ligands employed, such as cyano, amino, diol, and C₄, C₈ or C₁₈, and phenyl ligands, distribution of residual SiOH groups also play a major role in the separation process

In general most chromatographic media are based on polymeric or silica particles having irregular to spherical particle shape, different particle size and pore size. Most common chromatographic media were prepared by bonding to the polymeric or silica particles a range of alkyl groups with chain length of 1-30 carbon atoms. The octadecyl (C₁₈) alkyl is the most popular followed by C₈ and C₄ bonded silica. The next development was the use of end-capping, where a smaller reagent (TMS, trimethylsilyl chloride) was employed to cap the unreacted Si—OH groups. The degree of bonding varies between type of silica and it is reflected in the carbon loading as seen from percentage of surface coverage, which is a rough guide to the proportion of stationary phase, and hence, the overall retentivity property of a column.

In reversed-phase chromatography an aqueous organic mobile phase is employed and the separation is based on partition of the analyte between the mobile and stationary phase and is governed by polarity and hydrophobicity of the analytes. The strength of the eluent is governed by the proportion of organic modifier, usually either methanol, acetonitrile, or THF. Because of the interaction of each modifier with an analyte and ligands of the media can be different, selectivity or relative retention of any analyte compound depends on the polarity of the molecules and elution strength of the mobile phase. It is common to use a variety and varying amount of solvents in the mobile phase to elute compounds of interest from the column. However, for process application where a chromatography unit operation is used for manufacture, for safety and economic reasons, it would be highly preferable to be able to use the least amount of organic solvent as possible for eluting small molecules. However, it is not possible using currently available chromatographic media as most separation happens on the basis of partitioning in mobile phase and not on the basis of strong interaction of the analyte with ligands.

We have discovered that by having the presence of certain ligands on the media we can achieve better separation as it provide multiple interaction sites including hydrophobic vanderwalls interaction, pi-pi interaction and hydrogen bonds. Although normal preference for the organic component of the eluent is either methanol or acetonitrile for economy or efficiency, ideal solvent of elution would be water for several reasons. Many different reverse phase media are known in the market from several manufacturers including Mallinckrodt Baker, Inc., but unless there is a specific interaction, the selectivity differences between similar types of columns are usually less than the differences introduced on changing the eluent solvent.

One of the purposes of this invention is to show that the new reverse phase media described herein not only show unique separation but also elutes compounds of interest using water only as the mobile phase. Furthermore, this media can be used for separation of water-soluble analytes using highly aqueous mobile phase.

### SUMMARY OF THE INVENTION

The present invention provides a reverse phase chromatographic media selected from media of the formula:

[X—C₆H₄—(O)ₘ—(CH₂)ₙ]_{q}—Z

and hydrophobic end-capped media of said formula,
wherein n is a numeral of from 1 to 4, preferably 2 to 4, and more preferably 3 or 4, and still more preferably is 3, and m is 0 or 1, preferably 1, and when m is 1 X is selected from the group H, an alkyl group having from 1 to 6, preferably 1 to 4 and more preferably 2 to 4 carbon atoms, and a phenyl group, with X preferably being H, and when m is 0 then X is selected from an alkoxy group having from 1 to 6 carbon atoms, preferably 1 to 4 carbon atoms, and more preferably 1 to 2 carbon atoms, and still more preferably 1 carbon atom, and a phenoxy group, with X preferably being methoxy, Z is the backbone of a silica or hydrophilic polymer chromatographic support, and q is a number equal to the number of ligands attached to the backbone of the silica or hydrophobic polymer chromatographic support, with the proviso that when said reverse phase chromatographic media of the formula is not end-capped with hydrophobic groups X is not H when m=1. The invention provides such end-capped media of the formula having hydrophobic end-capping of silanol moieties on the backbone of the silica chromatographic support, or end-capping of hydroxyl, amine or imine moieties on the backbone of the hydrophilic polymer chromatographic support. The novel chromatographic media of the formula are prepared by reacting:
(a) a chromatographic media support selected from (1) a silica support having hydroxyl groups on the surface of the silica backbone or (2) a hydrophilic polymer support having hydroxyl, amine or imine groups on the surface of the polymer backbone,
with
(b) a reactant of the formula

[X—C₆H₄—(O)ₘ—(CH₂)ₙ]ₚ—Si(Y)₄₋ₚ

wherein p is a numeral of from 1 to 3 and is preferably 1, Y is a chlorine, bromine, iodine or alkoxy group having from 1 to 4 carbon atoms in the alkoxy group, and is preferably chlorine, and m, n and X are as defined above, whereby ligands of the formula

[X—C₆H₄—(O)ₘ—(CH₂)ₙ]—

are attached to the backbone of the silica or hydrophilic polymer support through a hydroxyl group on the silica backbone or through the hydroxyl, amine or imine groups on the hydrophilic polymer backbone to provide a reverse phase chromatographic media of the formula:

[X—C₆H₄—(O)ₘ—(CH₂)ₙ]_{q}—Z

wherein n is a numeral of from 1 to 4, preferably 2 to 4, and more preferably 3 or 4, and still more preferably is 3, and m is 0 or 1, preferably 1, and when m is 1 X is selected from the group H, an alkyl group having from 1 to 6, preferably 1 to 4 and more preferably 2 to 4 carbon atoms, and a phenyl group, with X preferably being H, and when m is 0 then X is selected from an alkoxy group having from 1 to 6 carbon atoms, preferably 1 to 4 carbon atoms, and more preferably 1 to 2 carbon atoms, and still more preferably 1 carbon atom, and a phenoxy group, with X preferably being methoxy, Z is the backbone of a silica or hydrophilic polymer chromatographic support, and q is a number equal to the number of ligands attached to the backbone of the silica or hydrophobic polymer chromatographic support, with the proviso that when said reverse phase chromatographic media of the formula is not end-capped with hydrophobic groups X is not H when m=1. The reactant is reacted with the silica support or the hydrophilic polymer support in a weight ratio of silica or hydrophilic polymer support to reactant of from about 20:1 to about 2:1, preferably from about 13:1 to about 5:1, and most preferably about 7:1. If it is desired that the reverse phase chromatographic media of the aforesaid formula have hydrophobic end-capping such media may be reacted with any suitable hydrophobic end-capping reactant to react the end-capping reactant with any of the remaining silanol groups on the backbone of the silica or with any of the remaining hydroxyl, amine or imine groups on the backbone of the hydrophilic polymer chromatographic support.

It has been discovered that the resulting chromatographic media with these ligands attached to the backbone of the silica or hydrophilic polymer support provides chromatographic media that offers analyte separation capability in the aqueous mobile phase. Furthermore, when said chromatographic media had been hydrophobic end-capped the resulting end-capped media has, compared to hydrophilic end-capped media, increased stability in aqueous media and increased hydrophobic interaction with ligand or end-groups for increased retention properties. Additionally, and surprisingly, the hydrophobic end-capped media allows separation in highly aqueous mobile phases.

### BRIEF DESCRIPTION OF THE DRAWINGS

The invention is illustrated by, but not limited to, the embodiment of the invention shown in the figures wherein:

FIG. 1 is a chromatogram of the separation of Application Example 1 of the separation of acetaminophen;

FIG. 2 is a chromatogram of the separation of Application Example 2 of the separation of caffeine;

FIG. 3 is a chromatogram of the separation of Application Example 3 of the separation of iodixanol;

FIG. 4 is a chromatogram of the separation of Application Example 4 of the separation of iodixanol;

FIG. 5 is a chromatogram of the separation of Application Example 5 of the separation of a mixture containing uracil, phenol, m-DETA and biphenyl; and

FIG. 6 is a chromatogram of the separation of the Comparative Application Example of the separation of iodixanol.

### DETAILED DESCRIPTION OF THE INVENTION

The invention provides a reverse phase chromatographic media selected from media of the formula:

[X—C₆H₄—(O)ₘ—(CH₂)ₙ]_{q}—Z

and hydrophobic end-capped media of said formula,
wherein n is a numeral of from 1 to 4, preferably 2 to 4, and more preferably 3 or 4, and still more preferably is 3, and m is 0 or 1, preferably 1, and when m is 1 X is selected from the group H, an alkyl group having from 1 to 6, preferably 1 to 4 and more preferably 2 to 4 carbon atoms, and a phenyl group, with X preferably being H, and when m is 0 then X is selected from an alkoxy group having from 1 to 6 carbon atoms, preferably 1 to 4 carbon atoms, and more preferably 1 to 2 carbon atoms, and still more preferably 1 carbon atom, and a phenoxy group, with X preferably being methoxy, Z is the backbone of a silica or hydrophilic polymer chromatographic support, and q is a number equal to the number of ligands attached to the backbone of the silica or hydrophobic polymer chromatographic support, with the proviso that when said reverse phase chromatographic media of the formula is not end-capped with hydrophobic groups X is not H when m=1. The invention provides such end-capped media of the formula having hydrophobic end-capping of silanol moieties on the backbone of the silica chromatographic support, or end-capping of hydroxyl, amine or imine moieties on the backbone of the hydrophilic polymer chromatographic support. The novel chromatographic media of the formula are prepared by reacting:
(b) a chromatographic media support selected from (1) a silica support having hydroxyl groups on the surface of the silica backbone or (2) a hydrophilic polymer support having hydroxyl, amine or imine groups on the surface of the polymer backbone,
with
(b) a reactant of the formula

[X—C₆H₄—(O)ₘ—(CH₂)ₙ]ₚ—Si(Y)₄₋ₚ

wherein p is a numeral of from 1 to 3 and is preferably 1, Y is a chlorine, bromine, iodine or alkoxy group having from 1 to 4 carbon atoms in the alkoxy group, and is preferably chlorine, and m, n and X are as defined above, whereby ligands of the formula

[X—C₆H₄—(O)ₘ—(CH₂)ₙ]—

are attached to the backbone of the silica or hydrophilic polymer support through a hydroxyl group on the silica backbone or through the hydroxyl, amine or imine groups on the hydrophilic polymer backbone to provide a reverse phase chromatographic media of the formula:

[X—C₆H₄—(O)ₘ—(CH₂)ₙ]_{q}—Z

wherein n is a numeral of from 1 to 4, preferably 2 to 4, and more preferably 3 or 4, and still more preferably is 3, and m is 0 or 1, preferably 1, and when m is 1 X is selected from the group H, an alkyl group having from 1 to 6, preferably 1 to 4 and more preferably 2 to 4 carbon atoms, and a phenyl group, with X preferably being H, and when m is 0 then X is selected from an alkoxy group having from 1 to 6 carbon atoms, preferably 1 to 4 carbon atoms, and more preferably 1 to 2 carbon atoms, and still more preferably 1 carbon atom, and a phenoxy group, with X preferably being methoxy, Z is the backbone of a silica or hydrophilic polymer chromatographic support, and q is a number equal to the number of ligands attached to the backbone of the silica or hydrophobic polymer chromatographic support, with the proviso that when said reverse phase chromatographic media of the formula is not end-capped with hydrophobic groups X is not H when m=1. The reactant is reacted with the silica support or the hydrophilic polymer support in a weight ratio of silica or hydrophilic polymer support to reactant of from about 20:1 to about 2:1, preferably from about 13:1 to about 5:1, and most preferably about 7:1. If it is desired that the reverse phase chromatographic media of the aforesaid formula have hydrophobic end-capping such media may be reacted with any suitable hydrophobic end-capping reactant to react the end-capping reactant with any of the remaining silanol groups on the backbone of the silica or with any of the remaining hydroxyl, amine or imine groups on the backbone of the hydrophilic polymer chromatographic support.

The reactant is reacted with the silica support or the hydrophilic polymer in a weight ratio of silica or hydrophilic polymer support to reactant of from about 20:1 to about 2:1, preferably from about 13:1 to about 5:1, and most preferably about 7:1.

If it is desired that the reverse phase chromatographic media of the aforesaid formula have hydrophobic end-capping, such media may be reacted with any suitable hydrophobic end-capping reactant to react the end-capping reactant with any of the remaining silanol groups on the backbone of the silica or with any of the remaining hydroxyl, amine or imine groups on the backbone of the hydrophilic polymer chromatographic support. Any suitable hydrophobic end-capping reactant capable of reacting with unreacted silanols groups on the backbone of the silica, or reacting with unreacted hydroxyl, amine or imine groups remaining on the backbone of the hydrophilic polymer chromatographic support may be employed in this invention. Suitable end-capping reactant include, but are not limited to, hexamethyldisilazane, 1-(trimethylsilyl)imidazole, and trialkylhalosilanes such as trimethylchlorosilane, and triethylchlorosilane. Hexamethyldisilazane and 1-(trimethylsilyl)imidazole are preferred as end-capping reactant, and hexamethyldisilazane is even more preferred. In general, the non-end capped material is reacted with suitable end-capping reagents using silica to reagents in a ratio of from 5:1 to 10:1 ratio in a suitable solvent such as toluene at room temperature or temperature up to 90° C. for up to 24 hours. The resulting product was washed with suitable solvents such as toluene and dried at 85° C.

An embodiment of this invention comprises a process for separating an analyte from a solution containing the analyte wherein the process comprises:

(a) providing a chromatographic column packed with a reverse phase chromatographic media of the formula:

[X—C₆H₄—(O)ₘ—(CH₂)ₙ]_{q}—Z

wherein n is a numeral of from 1 to 4, preferably 2 to 4, and more preferably 3 or 4, and still more preferably is 3, and m is 0 or 1, preferably 1, and when m is 1 X is selected from the group H, an alkyl group having from 1 to 6, preferably 1 to 4 and more preferably 2 to 4 carbon atoms, and a phenyl group, with X preferably being H, and when m is 0 then X is selected from an alkoxy group having from 1 to 6 carbon atoms, preferably 1 to 4 carbon atoms, and more preferably 1 to 2 carbon atoms, and still more preferably 1 carbon atom, and a phenoxy group, with X preferably being methoxy, Z is the backbone of a silica or hydrophilic polymer chromatographic support, and q is a number equal to the number of ligands attached to the backbone of the silica or hydrophobic polymer chromatographic support, with the proviso that when said reverse phase chromatographic media of the formula is not end-capped with hydrophobic groups X is not H when m=1, or such reverse phase chromatographic media that has hydrophobic end-capping;

(a) injecting the solution of the analyte into the packed column; and

(b) eluting the analyte.

The chromatographic media of this invention with these ligands attached to the backbone of the silica or hydrophilic polymer support, and particularly those with phenoxyalkyl ligands, especially phenoxypropyl ligands, and alkoxyphenyl alkyl ligands, especially, methoxyphenyl propyl ligands, provides chromatographic media that offers analyte separation capability in the highly aqueous mobile phase. For example media of this invention with phenoxypropyl ligands can separate iodixanol, namely 5-[acetyl-[3-[acetyl-[3,5-bis(2,3-dihydroxypropylcarbamoyl)-2,4,6-tri iodo-phenyl]amino]-2-hydroxy-propyl]amino]-N,N′-bis(2,3-dihydroxypropyl)-2,4,6-triiodo-benzene-1,3-dicarboxamide, from other related impurities without the use of any organic media and thus iodixanol can be separated using water as the only eluent. Similarly, media, particularly media of this invention with phenoxypropyl ligands, can elute acetaminophen using water as the mobile phase. The acetaminophen is loaded onto a column packed with a media of this invention and is eluted with water as a sharp peak as demonstrated in Application Example 1.

In accordance with one embodiment of the invention, one of the reverse phase media is prepared by reacting 3-phenoxypropyltrichlorosilane (C₉H₁₁Cl₃OSi, CAS No. 60333-76-8) with spherical silica 40-60 microns, 120 Å in toluene/methanol mixture at room temperature for about 16-20 hours.

In another embodiment of this invention, 50 grams of silica was slurried in 250 ml toluene containing 5 ml methanol and 7.5 grams of phenoxypropyltrichlorosilane was added thereto and reacted for about 6 hours at room temperature. The slurry was washed with methanol and dried at 85° C. The surface coverage based on % C was 179 microgram/m². The resultant media was packed in an analytical column (4.6×250 mm) and semi-prep column (10×250 mm) and tested for separation of several small molecules under different condition.

The silica or hydrophilic polymer support for the media of this invention can be any suitable hydroxylated silica or suitable hydrophilic polymer. The silica gel support for the media can be irregular or spherical having particle size generally in the range of about 2 micron to about 250 micron and pore size of about 30 Å to about 2000 Å. Similarly, hydrophilic polymer for the media of this invention beads can be irregular or spherical having particle size generally in the range of 2 micron to 250 micron and pore size of about 30 Å to about 2000 Å. The hydrophilic polymer is preferably polymer beads selected from the group of polymethacrylate, hydroxylated styrene-divinylbenzene, hydroxylated divinylbenzene, cellulose, or agarose, having hydroxyl, amine, or imine groups on the surface. For example, hydroxylated polymethacrylate can be derived from polymerization between glycideylmethacrylate (GMA) and ethyleneglycoldimethylacrylate (EGDM) followed by acid or base hydrolysis.

In another embodiment of the invention the media of the invention is used for the separation of small molecules of molecular weight of about 2000 or less, even about 1500 or less, and also 1000 or less, from highly aqueous mobile phases.

The materials synthesized in this invention are compared with the known silica media made with phenyl butyl ligand (Comparative Synthesis Example) for its iodixanol elution behavior (Comparative Application Example).

### Synthesis Example 1

50 g silica with an average particle size of 50 micron with a pore size of 130 Å was placed in a 1 L round bottom flask equipped with a funnel, agitator and positive nitrogen pressure inlet and 250 ml toluene and 5 ml methanol were added thereto and stirred at room temperature. 7.5 g of 3-Phenoxypropyl trichlorosilane was added to the flask in less than 1 minute and stirred at room temperature for about 16 hours. The slurry was filtered and washed with 250 ml methanol and dried 9t 85° C. overnight. Elemental analysis: C, 6.32%; H, 0.90%. Surface coverage: 179 microgram/m².

### Synthesis Example 2

200 g silica with an average particle size of 20 micron with a pore size of 130 Å was placed in a 2 L round bottom flask equipped with a funnel, agitator and positive nitrogen pressure inlet and 1000 mL toluene and 20 ml methanol were added thereto and stirred at room temperature. 30.0 g of 3-Phenoxypropyl trichlorosilane was added to the flask in less than 1 minute and stirred at room temperature for 16 hours. The slurry was filtered and washed with 1000 ml methanol and dried at 85° C. overnight. Elemental analysis: C, 6.57%; H, 1.00%. Surface coverage: 203 microgram/m².

### Synthesis Example 3

120 g silica with the average particle size of 10 micron with the pore size of 140 Å was placed in a 1 L round bottom flask equipped with a funnel, agitator and positive nitrogen pressure inlet and 500 ml toluene and 15 ml methanol were added thereto and stirred at room temperature. 18 g of 3-Phenoxypropyl trichlorosilane was added to the flask in less than 1 minute and stirred at room temperature for about 16 hours. The slurry was filtered and washed with 500 ml methanol and dried at 85° C. overnight. Elemental analysis: C, 5.92%; H, 0.78%. Surface coverage: 198 microgram/m².

### Synthesis Example 4

150 g silica with an average particle size of 50 micron with a pore size of 130 Å was placed in a 2 L round bottom flask equipped with a funnel, agitator and positive nitrogen pressure inlet and 750 ml toluene and 15 ml methanol were added thereto and stirred at room temperature. 22.5 g of methoxyphenyl propyl trichlorosilane (CAS No. 163155-57-5) was added to the flask in less than 1 minute and stirred at room temperature for about 16 hours. The slurry was filtered and washed with 750 ml methanol and dried at 85° C. overnight. Elemental analysis: C, 6.49%; H, 0.95%. Surface coverage: 175 microgram/m².

### Synthesis Example 5

1.0 Kg silica with the average particle size of 50 micron with the pore size of 120 Å was placed in a 1 L round bottom flask equipped with a funnel, agitator and positive nitrogen pressure inlet and 5 L toluene and 100 ml methanol were added thereto and stirred at room temperature. 150 g of 3-Phenoxypropyl trichlorosilane was added to the flask in less than 1 minute and stirred at room temperature for about 16 hours. The slurry was filtered and washed with 250 ml methanol and dried at 85° C. overnight. Elemental analysis: C, 6.38%; H, 1.13%. Surface coverage: 169 microgram/m²

### Comparative Synthesis Example

50 g silica with an average particle size of 50 micron with a pore size of 130 Å was placed in a 1 L round bottom flask equipped with a funnel, agitator and positive nitrogen pressure inlet and 250 ml toluene and 5 ml methanol were added thereto and stirred at room temperature. 7.5 g of 4-phenylbutyltrichlorosilane was added to the flask in less than 1 minute and stirred at room temperature for about 16 hours. The slurry was filtered and washed with 250 ml methanol and dried at 85° C. overnight. Elemental analysis: C, 7.51%; H, 1.13%. Surface coverage: 213 microgram/m².

### Synthesis Example 6

100 g silica bonded with 3-phenoxypropyl (C=6.06%) with an average particle size of 50 micron with a pore size of 130 Å was placed in a 2 L round bottom flask equipped with a funnel, agitator and positive nitrogen pressure inlet and 500 ml toluene was added thereto and stirred at room temperature. 12.5 g of hexamethyldisilazane (CAS No. 999-97-3) was added to the flask in less than 1 minute and stirred at room temperature for about 16-20 hours. The slurry was filtered and washed twice with 500 ml Toluene and three times with 500 ml methanol and dried at 85° C. overnight. Elemental analysis: C, 7.0%; H, 1.3%. Surface coverage: 196 microgram/m².

### Synthesis Example 7

100 g silica bonded with 3-phenoxypropyl (C=6.06%) with an average particle size of 50 micron with a pore size of 130 Å was placed in a 2 L round bottom flask equipped with a funnel, agitator and positive nitrogen pressure inlet and 500 ml toluene was added thereto and stirred at room temperature. 12.5 g of 1-(Trimethylsilyl)imidazole) (CAS No. 18156-74-6) was added to the flask in less than 1 minute and stirred at room temperature for about 16-20 hours. The slurry was filtered and washed twice with 500 ml Toluene and three times with 500 ml methanol and dried at 85° C. overnight. Elemental analysis: C, 7.11%; H, 0.89%. Surface coverage: 199 microgram/m².

### Application Example 1

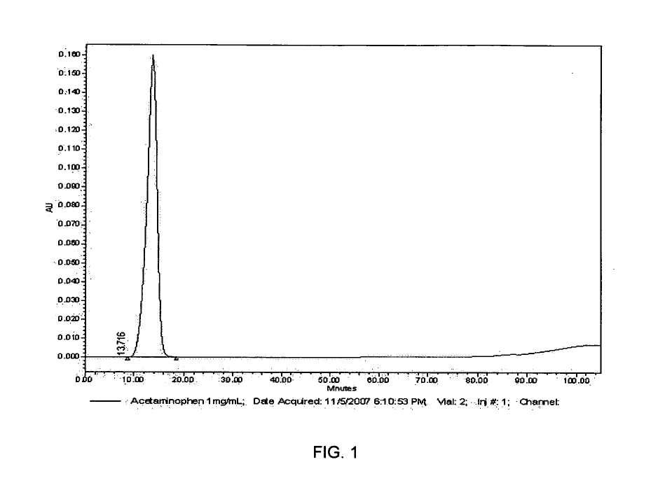

A chromatographic media containing phenoxy propyl ligand attached to silica as prepared in Synthesis Example 1 was packed in an analytical column (4.6×250 mm). 5 Microliters of a solution containing 1 mg/ml acetaminophen in water was injected to the column and eluted using a flow rate of 0.85 ml/min and the elution was monitored at 245 nm using water as a mobile phase for a period of up to about 45 minutes. The resulting chromatogram is shown in FIG. 1.

### Application Example 2

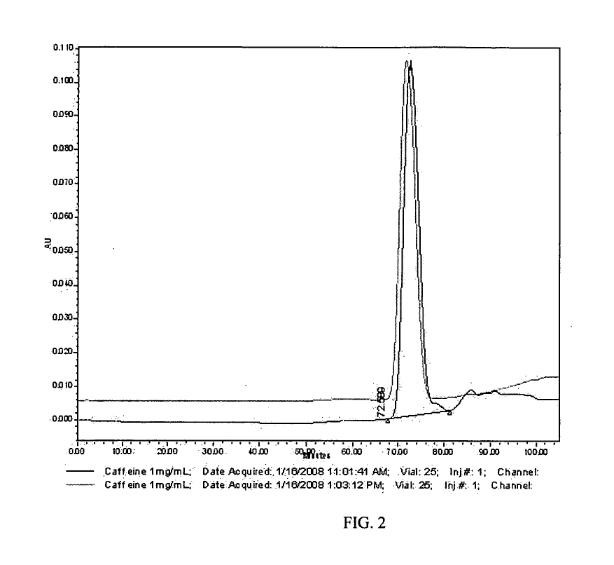

A chromatographic media containing phenoxy propyl ligand attached to silica as prepared in Synthesis Example 2 was packed in an analytical column (4.6×250 mm). 5 Microliters of a solution containing 1 mg/ml caffeine in water was injected to the column and eluted using a flow rate of 0.85 ml/min and the elution was monitored at 245 nm using water as a mobile phase for up to about 45 minutes and a 30 min gradient from 100% water to 50% methanol and 50% water. The resulting chromatogram is FIG. 2 showing elution of caffeine at 73 min.

### Application Example 3

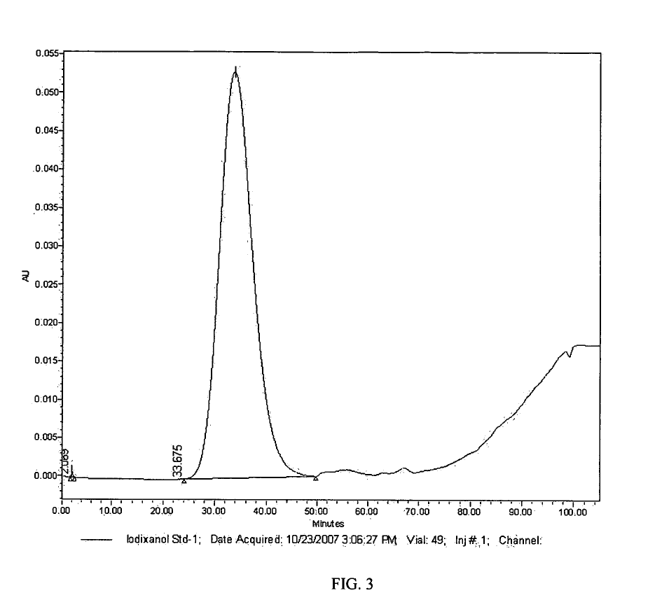

A chromatographic media containing phenoxy propyl ligand attached to silica as prepared in Synthesis Example 3 was packed in a semi-prep column (10 mm×250 mm). 25 Microliters of a solution containing 2.5 mg/ml iodixanol in water was injected into the column with a flow rate of 4.02 ml/min. The iodixanol elutes at 33. 7 min with only water as a mobile phase. The resulting chromatogram is FIG. 3.

### Application Example 4

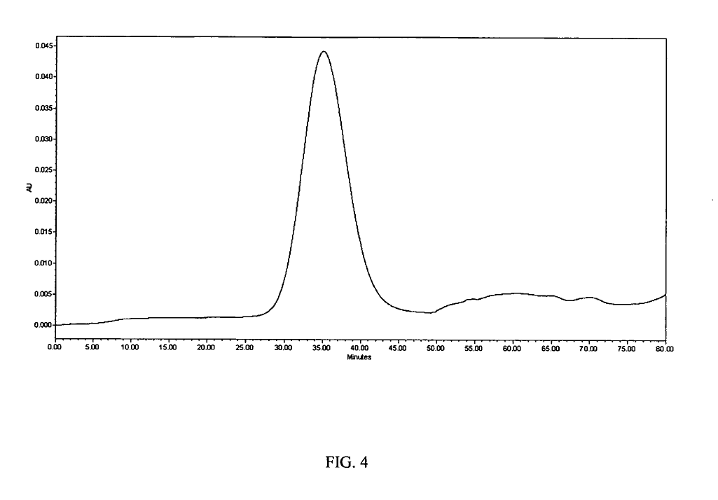

A chromatographic media containing methoxy phenyl propyl ligand attached to silica as prepared in Synthesis Example 4 was packed in a semi-prep column (10 mm×250 mm). 25 Microliters of a solution containing 2.5 mg/ml iodixanol in water was injected into the column with a flow rate of 4.02 ml/min. The iodixanol eluted at 33. 1 min with only water as a mobile phase. The chromatogram is FIG. 4.

### Application Example 5

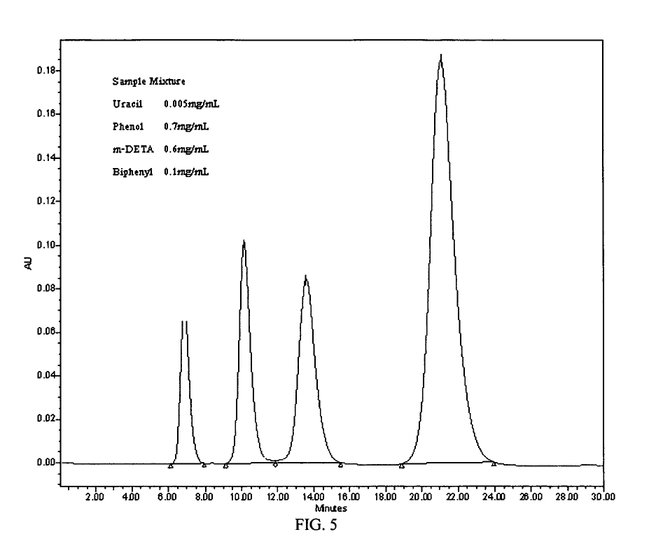

A chromatographic media containing phenoxy propyl ligand attached to silica as prepared in Synthesis Example 5 was packed in a semi-prep column (10 mm×250 mm). 50 Microliters of a solution containing mixture of uracil, phenol, m-DETA and biphenyl was injected into the column with a flow rate of 2 ml/min using 50/50 acetonitrile:water mobile phase and the resultant chromatogram is shown in FIG. 5.

### Comparative Application Example

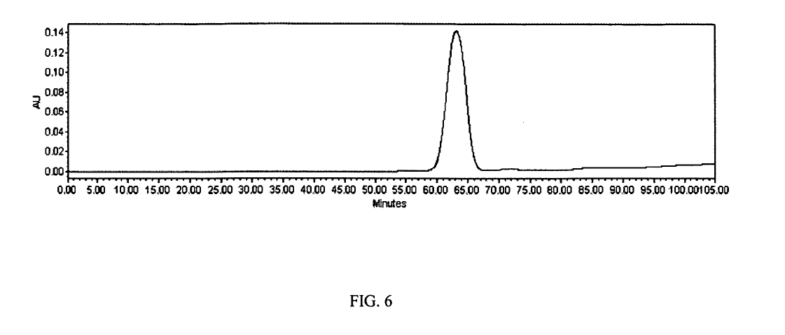

A chromatographic media containing phenyl butyl ligand attached to silica as prepared in the Comparative Synthesis Example was packed in an analytical column (4.6 mm×250 mm). 5 Microliters of a solution containing 2.5 mg/ml iodixanol in water was injected into the column with a flow rate of 0.85 ml/min. Using media with the phenyl butyl ligand and water as the mobile phase didn't elute iodixanol even up to 45 min in water. Rather the phenyl buty ligand media required 30% methanol to elute the iodixanol. The iodixanol eluted at 63 min with about 30% methanol in the mobile phase. The resulting chromatogram is FIG. 6. This is in comparison to media of current invention (Example 3, FIG. 3) shows that Iodixanol can be eluted and separated from highly aqueous solution.

While the invention has been described herein with reference to the specific embodiments thereof, it will be appreciated that changes, modification and variations can be made without departing from the spirit and scope of the inventive concept disclosed herein. Accordingly, it is intended to embrace all such changes, modification and variations that fall with the spirit and scope of the appended claims.

1. A reverse phase chromatographic media selected from media of the formula:
[X—C₆H₄—(O)ₘ—(CH₂)ₙ]_{q}—Z
and hydrophobic end-capped media of said formula,
wherein n is a numeral of from 1 to 4, and m is 0 or 1, and when m is 1 X is selected from the group H, an alkyl group having from 1 to 6 carbon atoms and a phenyl group, and when m is 0 then X is selected from an alkoxy group having from 1 to 6 carbon atoms and a phenoxy group, Z is the backbone of a silica or hydrophilic polymer chromatographic support, and q is a number equal to the number of ligands attached to the backbone of the silica or hydrophobic polymer chromatographic support, with the proviso that when said reverse phase chromatographic media of the formula is not end-capped with hydrophobic groups X is not H when m=1.

2. A reverse phase chromatographic media according to claim 1 wherein Z is a silica support backbone.

3. A reverse phase chromatographic media according to claim 1 wherein Z is a silica support backbone, X is H, m=1 and n=3.

4. A reverse phase chromatographic media according to claim 3 wherein the media has hydrophobic end-capping and the hydrophobic end-capping is by hexamethyldisilazane.

5. A reverse phase chromatographic media according to claim 1 wherein Z is a silica support backbone, X is a methoxy group, m=0 and n=3.

6. A process for the preparation of a reverse phase chromatographic media of the formula:
[X—C₆H₄—(O)ₘ—(CH₂)ₙ]_{q}—Z
wherein n is a numeral of from 1 to 4, and m is 0 or 1, and when m is 1 X is selected from the group H, an alkyl group having from 1 to 6 carbon atoms and a phenyl group, and when m is 0 then X is selected from an alkoxy group having from 1 to 6 carbon atoms and a phenoxy group, Z is the backbone of a silica or hydrophilic polymer chromatographic support, and q is a number equal to the number of ligands attached to the backbone of the silica or hydrophobic polymer chromatographic support, with the proviso that when said reverse phase chromatographic media of the formula is not end-capped with hydrophobic groups X is not H when m=1, the process comprises reacting
(a) a chromatographic media support selected from (1) a silica support having hydroxyl groups on the surface of the silica backbone or (2) a hydrophilic polymer support having hydroxyl, amine or imine groups on the surface of the polymer backbone,
with
(b) a reactant of the formula
X—C₆H₄—(O)ₘ—(CH₂)ₙ]ₚ—Si(Y)₄₋ₚ
wherein p is a numeral of from 1 to 3, Y is selected from the group consisting of chlorine, bromine, iodine and an alkoxy group having from 1 to 4 carbon atoms in the alkoxy group, and m, n and X are as defined above, and
(c) optionally reacting the resulting reverse phase chromatographic media of the formula:
[X—C₆H₄—(O)ₘ—(CH₂)ₙ]_{q}—Z
with a hydrophobic end-capping reactant to provide hydrophobic end-capping of said media.

7. A process according to claim 6 wherein p=1 and the weight ratio of silica or hydrophilic polymer support reacted with the reactant is in a range of from about 20:1 to about 2:1.

8. A process according to claim 7 wherein Z is a silica support.

9. A process according to claim 8 wherein p=1, X is H, m=1, n=3 and Y is chlorine and the resulting media is reacted with a hydrophobic end-capping reagent.

10. A process according to claim 9 wherein the end-capping reagent is hexamethyldisilazane.

11. A process according to claim 8 wherein p=1, X is methoxy, m=0, n=3, and Y is chlorine.

12. A process for separating an analyte from a solution containing the analyte, the process comprises:
(a) providing a chromatographic column packed with a reverse phase chromatographic media selected from media of the formula:
[X—C₆H₄—(O)ₘ—(CH₂)ₙ]_{q}—Z
and hydrophobic end-capped media of said formula,
wherein n is a numeral of from 1 to 4, and m is 0 or 1, and when m is 1 X is selected from the group H, an alkyl group having from 1 to 6 carbon atoms and a phenyl group, and when m is 0 then X is selected from an alkoxy group having from 1 to 6 carbon atoms and a phenoxy group, Z is the backbone of a silica or hydrophilic polymer chromatographic support, and q is a number equal to the number of ligands attached to the backbone of the silica or hydrophobic polymer chromatographic support, with the proviso that when said reverse phase chromatographic media of the formula is not end-capped with hydrophobic groups X is not H when m=1;
(b) injecting the solution of the analyte into the packed column; and
(c) eluting the analyte.

13. A process according to claim 12 wherein Z is a silica support.

14. A process according to claim 12 wherein Z is a silica support, X is H, m=1 and n=3.

15. A process according to claim 14 wherein the media has hydrophobic end-capping and the hydrophobic end-capping is by hexamethyldisilazane.

16. A process according to claim 12 wherein Z is a silica support, X is a methoxy group, m=0 and n=3.

17. A process according to claim 12 wherein the analyte is acetaminophen and the elution of the acetaminophen occurs in a water mobile phase.

18. A process according to claim 17 wherein in the media Z is a silica support, X is H, m=1 and n=3.

19. A process according to claim 12 wherein the analyte is iodixanol and the elution of the iodixanol occurs in a water mobile phase.

20. A process according to claim 19 wherein in the media Z is a silica support X is a methoxy group, m=0 and n=3.

21. A process according to claim 12 wherein the analyte is an analyte of molecular weight of about 200 or less and the elution of the analyte occurs in a water mobile phase.

22. A process according to claim 21 wherein in the media Z is a silica support, X is H, m=1 and n=3 and the media has hydrophobic end-capping by hexamethyldisilazane.

23. A process according to claim 21 wherein in the media Z is a silica support, X is a methoxy group, m=0 and n=3.
